(19) United States
(12) Patent Application Publication
(10) Pub. No.: US 2015/0218436 A1
(43) Pub. Date: Aug. 6, 2015

(54) BIODEGRADABLE CHELANT FOR SURFACTANT FORMULATION

(71) Applicant: Huntsman Petrochemical LLC, The Woodlands, TX (US)

(72) Inventors: Srinivasa S. Godavarthy, The Woodlands, TX (US); David C. Lewis, Conroe, TX (US); Guy Biesmans, Everberg (BE); Luis C. Salazar, Spring, TX (US); Farron W. Miller, Tomball, TX (US)

(73) Assignee: HUNTSMAN PETROCHEMICAL LLC, The Woodlands, TX (US)

(21) Appl. No.: 14/401,565

(22) PCT Filed: Sep. 16, 2013
(86) PCT No.: PCT/US13/59859

§ 371 Date: Nov. 17, 2014

Related U.S. Application Data
(60) Provisional application No. 61/708,263, filed on Oct. 1, 2012.
(60) Provisional application No. 61/816,249, filed on Apr. 26, 2013.

(51) Int. Cl. C09K 8/584; E21B 43/16

(52) U.S. Cl. CPC C09K 8/584; E21B 43/16

(57) ABSTRACT

The present disclosure provides a surfactant composition for use in treating and recovering oil from an oil-bearing subterranean formation. The surfactant composition includes a primary surfactant and a biodegradable chelant comprising ethylenediamine disuccinc acid and/or sodium salts thereof. The composition may be injected into one or more injection wells and into the subterranean formation and oil can then be subsequently recovered from one or more producing wells

### FIELD OF THE INVENTION

The present disclosure is directed to surfactant compositions containing a primary surfactant and a biodegradable chelant and a process for recovering oil from subterranean oil-bearing reservoirs employing such compositions.

### BACKGROUND INFORMATION

Crude oil can be recovered from oil-bearing reservoirs by processes generally designated primary, secondary and tertiary recovery. In primary recovery, oil is produced through a producing well by taking advantage of the pressure exerted on underground pools of oil by gas or water present with the oil. Approximately 20% of the oil in place is recovered by this process. Once the pressure has been depleted, other means of recovering the remaining oil must be employed. In secondary and tertiary recovery processes, the well can be flooded via the injection of a fluid or gas to force the oil to the surface. Water flooding is the most widely used fluid. However, water does not readily displace the oil because of high interfacial tension between the two liquids which results in high capillary pressure that traps the oil in porous media.

The addition of chemicals to the injection liquid has been attempted to further improve oil recovery in flooding techniques. One of the more promising includes the addition of a surfactant and optionally alkali to the injection liquid to form a surfactant polymer formulation or alkaline surfactant polymer formulation. While all the mechanisms involved are not fully understood, it's widely believed that the use of such formulations aids in reducing the oil-water interfacial tension in the reservoir thereby enhancing the recovery of oil. Typical surfactants which can be added include ether sulfates, ether carboxylates, internal olefin sulfonates or alkyl/alkylaryl sulfonates. While each surfactant compound differs in their temperature applicability, all the surfactants listed above exhibit limited performance in the presence of divalent ions (e.g. calcium and magnesium) that are contained in the injection liquid. Removing the divalent ions in a softening process adds significant cost and may present barriers in offshore or remote areas. The addition of ethylenediaminetetraacetic acid (EDTA). EDTA salts, nitrilotriacetic acid (NTA) and phosphates to the flooding liquid have been used in order to chelate the divalent ions (see, for example, U.S. Pat. No. 8,188,012 and US Pat. Publ. No. 2011/0290482)). However, NTA is a known carcinogen while EDTA, EDTA salts and phosphates suffer from poor biodegradability.

### SUMMARY OF THE INVENTION

The present disclosure relates to a surfactant composition for treating an oil-bearing subterranean formation comprising a primary surfactant and a biodegradable chelant comprising ethylenediamine disuccinc acid and/or sodium salts thereof.

In a further embodiment, the present disclosure provides a process for preparing a surfactant composition for treating an oil-bearing subterranean formation by combining a primary surfactant with a biodegradable chelant comprising ethylenediamine disuccinc acid and/or its sodium salts and water.

In a still further embodiment, the present disclosure provides a process for the recovery of oil from an oil-bearing subterranean formation by injecting a surfactant composition containing a primary surfactant and a biodegradable chelant comprising ethylenediamine disuccinc acid and/or sodium salts thereof and water into one or more injection wells and into the subterranean formation and recovering the oil from one or more producing wells. The injection well and the producing well may be the same well or different wells.

### DETAILED DESCRIPTION

If appearing herein, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical object of the article. By way of example, “a primary surfactant” means one primary surfactant or more than one primary surfactant.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

For methods of treating an oil-bearing subterranean formation, the term “treating” includes placing a chemical within an oil-bearing subterranean formation using any suitable manner known in the art, for example, pumping, injecting, pouring, releasing, displacing, squeezing, spotting, or circulating the chemical into the oil-bearing subterranean formation.

The term “alkyl” is inclusive of both straight chain and branched chain groups and of cyclic groups. In some embodiments, the alkyl group may have up to 40 carbons (in some embodiments up to 30, 20, 15, 12, 10, 8, 7, 6, or 5 carbons) unless otherwise specified. Cyclic groups can be monocyclic or polycyclic, and in some embodiments, can have from 3 to 10 carbon atoms.

The term “aryl” includes carbocyclic aromatic rings or ring systems, for example, having 1, 2 or 3 rings and optionally containing at least one heteroatom (e.g. O, S or N) in the ring. Examples of aryl groups include phenyl, naphthyl, biphenyl, fluorenyl, furyl, thienyl, pyridyl, quionlinyl, isoquinlinyl, indoyl, isoindolyl, triazolyl, pyrrolyl, tetrazolyl, imidazolyl, pyrazolyl, oxazolyl, and thiazolyl.

The term “alkylaryl” refers to an aryl moiety to which an alkyl group is attached.

The term “alkali metal” refers to Group IA metals of the Periodic Table.

As used herein, the term “substantially free” means, when used with reference to the substantial absence of a material in a composition, that such a material is present, if at all, as an incidental impurity or by-product. In other words, the material does not affect the properties of the composition.

The phrase “subterranean formation” encompasses both areas below exposed earth and areas below earth covered by water, such as an ocean or fresh water.

The present disclosure generally provides a surfactant composition for treating and recovering oil from an oil-bearing subterranean formation. According to one embodiment, the surfactant composition includes a primary surfactant and a biodegradable chelant comprising ethylenediamine disuccinc acid and/or sodium salts thereof. It has been surprisingly found that the addition of ethylenediamine disuccinc acid and/or its sodium salts to the composition act as chelating agents to prevent precipitation of divalent cations, such as calcium, magnesium, barium and strontium. Use of ethylenediamine disuccinc acid and/or its sodium salts allows for: the elimination of the need to soften waters containing divalent cations and the inherent cost of equipment involved in softening; elimination of the cost for disposal of sludge from such a softening process; and elimination of the use of higher quality water thus allowing for the use of indigenous water rather than the securing and transporting of higher quality water from remote locations. In addition, ethylenediamine disuccinc acid and/or its sodium salts act as an alkali agent to: increase the pH of the surfactant composition to high levels where natural soaps can be generated from naphthalenic acids in reactive crude oils; alter the wettability of the formation; increase the viscosity of the injected surfactant composition; lower surfactant adsorption to rock within the formation; and otherwise cause more of the residual oil to be mobilized and flow to the producing wells by a variety of well known and established mechanisms. Moreover, co-surfactants and solvents that are generally included to improve stability of the surfactant composition can be eliminated or substantially reduced thereby decreasing cost. Finally, ethylenediamine disuccinc acid and its sodium salts are biodegradable making the composition environmentally friendly.

As noted above, the surfactant composition includes a primary surfactant. According to one embodiment, the primary surfactant comprises an alkylaryl sulfonate. In one particular embodiment, the alkylaryl sulfonate is a compound represented by the general formula (I):

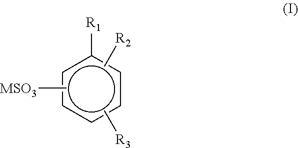

where R₁ is hydrogen or an alkyl group containing from 1 to 3 carbon atoms, R₂ is hydrogen or an alkyl group containing from 1 to 3 carbon atoms, R₃ is an alkyl group having from 8 to 40 carbons and M is a monovalent cation. In one embodiment, M is an alkali metal, ammonium or substituted ammonium. Examples of substituted ammonium include ammonium independently substituted with from 1 to 4 aliphatic or aromatic hydrocarbyl groups having from 1 to 15 carbons.

The compound of formula (I) may be obtained by the alkylation of an aromatic compound. In one embodiment, the aromatic compound is benzene, toluene, xylene or a mixture thereof. For embodiments where the aromatic compound includes xylene, the xylene compound may be ortho-xylene, meta-xylene, para-xylene, or a mixture thereof.

The aromatic compound may be alkylated with a mixture of normal alpha olefins containing from C₈ to C₄₀, carbons and in some embodiment, C₁₄ to C₃₀ carbons to yield an aromatic alkylate. The aromatic alkylate is then sulfonated to form an alkylaromatic sulfonic acid which is then neutralized with a source of alkali or alkaline earth metal or ammonia thereby producing an alkylaryl sulfonate compound. In one embodiment, the source is an alkali metal hydroxide, such as, but not limited to, sodium hydroxide or potassium hydroxide.

According to one embodiment, the surfactant composition comprises from about 0.005 to about 10 weight percent actives of the primary surfactant, based on the total weight of the surfactant composition. As used herein, the term “actives” refers to the concentration of the monovalent cation salts of each alkylaryl sulfonate species present. In another embodiment, the surfactant composition comprises from about 0.01 to about 5 weight percent actives of the primary surfactant, based on the total weight of the surfactant composition. In still another embodiment, the surfactant composition comprises from about 0.5 to about 3 weight percent actives of the primary surfactant, based on the total weight of the surfactant composition.

The surfactant composition further includes a biodegradable chelant comprising ethylenediamine disuccinc acid and/or sodium salts thereof. Ethylenediamine disuccinc acid is a compound having a structure as shown in formula (II):

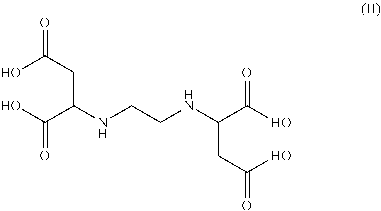 [SMILES: O=C(O)CC(NCCNC(CC(=O)O)C(=O)O)C(=O)O]

The structure includes two stereogenic centers and three possible stereoisomers, [R,R], [R,S] and [S,S]. In this disclosure, the term “EDDS” is used to denote the structure shown above in formula (II) while the term “EDDS sodium salt” is used to refer to succinate salts in which 1, 2 3 or 4 of the acid groups have been neutralized or partially neutralized by sodium hydroxide. In the present disclosure, the biodegradable chelant may comprise any one or mixture of the stereoisomers. Thus is may be selected from [R,R]-EDDS, [R,S]-EDDS, [S,S]-EDDS, [R,R]-EDDS sodium salt, [R,S]-EDDS sodium salt, [S,S]-EDDS sodium salt, and mixtures thereof. The [S,S] stereoisomer is highly biodegradable, thus, according to an embodiment, substantially all of EDDS and/or EDDS sodium salt is in the [S,S] form. In other embodiments, at least 50 weight percent of EDDS and/or EDDS sodium salt is in the [S,S] form, based on the total weight of EDDS and EDDS sodium salt. In still other embodiments, at least 70 weight percent of EDDS and/or EDDS sodium salt is in the [S,S] form, based on the total weight of EDDS and EDDS sodium salt.

In some embodiments, EDDS is synthesized from crude and/or pure maleic anhydride and ethylenediamine. Neutralization or partial neutralization of EDDS can produce EDDS sodium salt. It has been surprisingly found that the chelation of divalent ions by EDDS sodium salt which has been synthesized from crude maleic anhydride is slightly better than that for EDTA (a chelation value of 5.4 vs. 5 respectively) while the chelation of divalent ions achieved by EDDS sodium which has been synthesized from pure maleic anhydride is twice that for EDTA (a chelation value of 10. vs. 5, respectively).

A more complete disclosure for synthesizing EDDS and EDDS sodium salt can be found at, for example, U.S. Pat. No. 3,158,635, U.S. Pat. No. 4,704,233 and WO 1998043944, the entire contents of which are hereby incorporated herein by reference.

In one particular embodiment, the surfactant composition is substantially free of EDTA, EDTA salts and phosphate compounds. In another embodiment, the surfactant composition is substantially free of EDTA, EDTA salts and phosphate compounds and further includes at least one chelating agent selected from ascorbic acid, tetrasodium iminodisuccinate, citric acid, dicarboxymethylglutamic acid, maleic acid, diethylenetriaminepentacetic acid, cyclohexan trans-1,2-diaminetetraacetic acid, ethanoldiglycine, diethanolglycine, hydroxyethyl-ethylene-diaminetriacetic acid, ethylene bis[2-(o-hydroxyphenyl)-glycine], nitrilotriacetic acid (NTA), a nonpolar amino acid, methionine, oxalic acid, a polar amino acid, arginine, asparagine, aspartic acid, glutamic acid, glutamine, lysine, ornithine, a siderophore, desferrioxamine B, hydrolysed wool, succinic acid, sodium metaborate, sodium silicate, sodium orthosilicate, and any mixture thereof.

According to another embodiment, the surfactant composition comprises from about 0.005 to about 10 weight percent of the biodegradable chelant, based on the total weight of the surfactant composition. In another embodiment, the surfactant composition comprises from about 0.01 to about 5 weight percent of the biodegradable chelant, based on the total weight of the surfactant composition. In yet another embodiment, the surfactant composition comprises from about 0.1 to about 3 weight percent of the biodegradable chelant, based on the total weight of the surfactant composition. In a further embodiment, the surfactant composition comprises at least about 1 weight percent, preferably at least about 2 weight percent, and even more preferably at least about 3.5 weight percent of the biodegradable chelant, based on the total weight of the surfactant composition. In still another embodiment, the surfactant composition comprises the biodegradable chelant in an amount to provide a weight ratio of biodegradable chelant to divalent cations present in the composition of at least about 4.5:1, preferably at least about 7:1 and more preferably at least about 9:1.

The surfactant composition may further include water. In one embodiment, the water is hard water, hard brine or a mixture thereof. In another embodiment, the water is produced water that has been treated with, for example, salt or alkali.

In another embodiment, the surfactant composition may optionally comprise a co-surfactant. Co-surfactants can include one or more anionic, nonionic or amphoteric surfactants generally known in the art to be effective in reducing the interfacial tension between a composition injected into an oil-bearing subterranean formation for recovering oil and the residual oil. Cationic surfactants may also be employed, however, they are usually less effective and more costly. Examples of anionic surfactants include, but are not limited to, alkoxylated alkylphenol sulfonates, alkoxylated linear or branched alcohol sulfonates, alkyl diphenylether sulfonates, sulfonated alpha-olefins, and alkoxylated mono and diphosphate esters. Examples of nonionic surfactants include, but are not limited to, alkylphenols, alkoxylated linear or branched alcohols, and alkyl polyglucosides. Amphoteric surfactants include, but are not limited to, betaines, sulfobetaines, amidopropyl betaines, and amine oxides.

In one embodiment, the surfactant composition comprises from about 0 to about 6 weight percent actives of the co-surfactant, based on the total weight of the surfactant composition. In another embodiment, the surfactant composition comprises from about 0.025 to about 5 weight percent actives of the co-surfactant, based on the total weight of the surfactant composition. In still another embodiment, the surfactant composition comprises from about 0.5 to about 3 weight percent actives of the co-surfactant, based on the total weight of the surfactant composition.

In yet another embodiment, the surfactant composition may optionally comprise a solvent. Examples of suitable solvents include, but are not limited to, alcohols, such as lower carbon chain alcohols, for example, isopropyl alcohol, ethanol, n-propyl alcohol, n-butyl alcohol, sec-butyl alcohol, n-amyl alcohol, sec-amyl alcohol, n-hexyl alcohol, and sec-hexyl alcohol; alcohol ethers, polyalkylene alcohol ethers, such as ethylene glycol monobutyl ether, polyalkylene glycols, such as ethylene glycol and propylene glycol, poly(oxyalkylene)glycols, such as diethylene glycol, poly(oxyalkylene)glycol ethers, or any mixtures thereof.

In one embodiment, the surfactant composition comprises from about 0 to about 15 weight percent of solvent, based on the total weight of the surfactant composition. In another embodiment, the surfactant composition comprises from about 0.01 to about 10 weight percent actives of solvent, based on the total weight of the surfactant composition. In still another embodiment, the surfactant composition comprises from about 0.5 to about 5 weight percent of the solvent, based on the total weight of the surfactant composition.

In still another embodiment, the surfactant composition may optionally comprise a polymer. Examples of polymers include, but are not limited to, high molecular weight acrylic acid-acrylamide copolymers, acrylic acid-acrylamide-diacetone acrylamide terpolymers, partially hydrolyzed polyacrylamides, hydroxyethyl cellulose, carboxymethyl cellulose, polyacrylamides, polyoxyethylenes, modified starches, heteropolysaccharides obtained by fermentation of starch derived sugar, polyvinyl alcohol, polyvinyl pyrrolidone and polystyrene sulfonates.

In one embodiment, the surfactant composition comprises from about 0 to about 2 weight percent of polymer, based on the total weight of the surfactant composition. In another embodiment, the surfactant composition comprises from about 0.01 to about 1 weight percent of polymer, based on the total weight of the surfactant composition. In still another embodiment, the surfactant composition comprises from about 0.2 to about 0.5 weight percent of polymer, based on the total weight of the surfactant composition.

In still another embodiment, the surfactant composition may be optionally neutralized with an alkali metal hydroxide, carbonate or chloride. In one embodiment, the alkali metal hydroxide, carbonate or chloride is added to the surfactant composition prior to being pumped into the oil-bearing subterranean formation. In another embodiment, the surfactant composition contains from about 0.01 weight percent to about 2 weight percent, for e.g., from about 0.05 weight percent to about 1.5 weight percent or from about 0.01 weight percent to about 1 weight percent, based on the total weight of the surfactant composition.

The surfactant composition may be prepared by a process of mixing a primary surfactant with a biodegradable chelant comprising ethylenediamine disuccinc acid and/of sodium salts thereof and water. The components may be mixed together in any order using customary devices, such as a stirred vessel or static mixer. Once formulated, the surfactant composition (injection composition) may be packaged in any one of a variety of containers such as a steel, tin, aluminium, plastic or glass container.

The surfactant composition described above may be injected into one or more injection wells such that oil is subsequently produced from one or more producing wells. In one embodiment, the injection well and producing well are the same well. In another embodiment, the injection well and producing well are adjacent to one another. In most embodiments, the oil-bearing subterranean formation conditions are between about 25° C. and about 120° C.

Consideration must be given to the fact that although this disclosure has been described and disclosed in relation to certain preferred embodiments, obvious equivalent modifications and alterations thereof will become apparent to one of ordinary skill in this art upon reading and understanding this specification and the claims appended hereto. The present disclosure includes the subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claim so modified. This also includes combination of the features and/or limitations of one or more of the independent claims with the features and/or limitations of another independent claim to arrive at a modified independent claim, with the remaining dependent claims in their original text being read and applied to any independent claim so modified. Accordingly, the presently disclosed invention is intended to cover all such modifications and alterations, and is limited only by the scope of the claims which follow, in view of the foregoing and other contents of this specification.

What is claimed is:

1. A surfactant composition for treating an oil-bearing subterranean formation comprising a primary surfactant and a biodegradable chelant comprising ethylenediamine disuccinc acid and/or sodium salts thereof.

2. The surfactant composition according to claim 1, wherein the primary surfactant is an alkylaryl sulfonate.

3. The surfactant composition according to claim 2, wherein the alkylaryl sulfonate is a compound represented by the general formula (I): 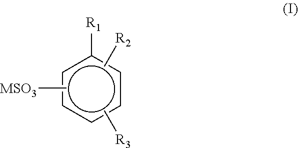
wherein R₁ is hydrogen or an alkyl group containing from 1 to 3 carbon atoms, R₂ is hydrogen or an alkyl group containing from 1 to 3 carbon atoms, R₃ is an alkyl group having from 8 to 40 carbons and M is a monovalent cation.

4. The surfactant composition according to claim 3, wherein M is an alkali metal, ammonium or ammonium independently substituted with from 1 to 4 aliphatic or aromatic hydrocarbyl groups having from 1 to 15 carbons.

5. The surfactant composition according to claim 1, wherein at least 50 weight percent of ethylenediamine disuccinc acid and/or sodium salts thereof is in the [S,S] form, based on the total weight of ethylenediamine disuccinc acid and/or sodium salts thereof.

6. The surfactant composition according to claim 1, wherein ethylenediamine disuccinc acid and/or sodium salts thereof is synthesized from crude maleic anhydride and diethlyeneamine.

7. The surfactant composition according to claim 1, wherein the surfactant composition is substantially free of EDTA, EDTA salts and phosphates.

8. The surfactant composition according to claim 1, wherein the composition further comprises a co-surfactant, solvent or polymer.

9. The surfactant composition according to claim 1, wherein the composition further comprises water.

10. The surfactant composition according to claim 9, wherein the water is hard water or hard brine.

11. A method of preparing a surfactant composition for treating an oil-bearing subterranean formation comprising mixing a primary surfactant, with a biodegradable chelant comprising ethylenediamine disuccinc acid and/or sodium salts thereof and water

12. A process for recovering oil from an oil-bearing subterranean formation comprising injecting the surfactant composition comprising a primary surfactant and a biodegradable chelant comprising ethylenediamine disuccinc acid and/or sodium salts thereof and water into one or more injection wells such that oil is subsequently produced from one or more producing wells.
